(19) United States
(12) Patent Application Publication
(10) Pub. No.: US 2011/0200153 A1
(43) Pub. Date: Aug. 18, 2011

(54) MAGNETIC AND ELECTROSTATIC NUCLEAR FUSION REACTOR

(76) Inventor: Moacir L. Ferreira, JR., Curitiba-pr (BR)

(21) Appl. No.: 13/124,483

(22) PCT Filed: Oct. 16, 2008
(86) PCT No.: PCT/IB08/54254

§ 371 Date: Apr. 15, 2011

(51) Int. Cl. H05H 1/11; G21B 1/00

(52) U.S. Cl. 376/127; 376/147

(57) ABSTRACT

An apparatus and method for confining and fusing charged particles. The charged particles have positive and negative ions from neutronic and aneutronic fuels. For confining radially charged particles, at least two, preferably six, magnetic fields to form a cusp region for injecting charged particles. An electric field at the cusp region for accelerating charged particles, and an opposite electric field for trapping longitudinally charged particles allowing only charged products to escape. The charged products are worthwhile for spacecraft propulsion and direct electricity conversion. The electrostatic acceleration method can reach great kinetic energy (7 billion ° C.) at low energy consumption. The preferred embodiment achieves a true three-dimensional confinement plus a three-dimensional charged particles injection. Also disclosed is an elementary resonance method for increasing fusion rate, a highly efficient direct electricity conversion by neutralization process, and a system for recycling magnets bore heat energy for generating electricity, becoming self-sustaining.

### TECHNICAL FIELD

This invention relates to a method and apparatus for energy production and spacecraft propulsion from nuclear fusion reactions and in particular to a controlled nuclear fusion reactor relying on electrostatic and magnetic confinement.

### BACKGROUND ART

Nuclear fusion takes place when light atomic nucleus with sufficient kinetic energy collides with each other to combine, overcoming electrostatic force repulsion, to form a heavier atomic nucleus releasing a tremendous amount of energy.

Nuclear fusion reactions have an energy density many times greater than nuclear fission. The nuclear fission involving uranium-235 and plutonium-239 produce more radiation hazards and radioactive waste than the conventional neutronic nuclear fusion involving deuterium and tritium. Both release millions of times more energy than the chemical reactions.

The development of a workable, self-sustaining, highly efficient and controlled nuclear fusion reactor for energy production has been tried for several decades.

To date, no practical nuclear fusion reactor was able to, at the same time, confine and keep the reactants with enough kinetic energy until they fuse at expressive rates and, mainly, release more energy than they consume.

Some reactors with different approaches have been tried: Tokamak, Levitated Dipole, Riggatron, Field-Reversed Configuration, Reversed Field Pinch, Magnetic Mirror Fusion Reactor, Spheromak, Laser Fusion, Z-machine, Focus Fusion, Farnsworth-Hirsch Fusor, Bussard Polywell, Muon-catalyzed Fusion, Heavy Ion Fusion, Magnetized Target Fusion, Colliding Plasma Toroid Fusion, Cold Fusion, Sonofusion, Pyroelectric Fusion and others.

The most promising nuclear fusion reactor design currently being developed and tested is a Tokamak type called ITER (International Thermonuclear Experimental Reactor) which relies on toroidal magnetic field to confine usually a mix of deuterium and tritium. The Tokamak reactors are giants and require a considerable amount of energy, much more than it produces, to maintain the magnetic field and the reactants with enough kinetic energy to fuse. The toroidal magnetic fields confines efficiently in two dimensions, i.e. only radially, allowing plasma rotate longitudinally in a closed path generating loss by electromagnetic radiation (synchrotron radiation) decreasing the plasma kinetic energy lowering the probability of fusion reactions and generates a plasma instability problem due to centrifugal force of particles moving along the curved toroidal magnetic field. Thus, it is inefficient for now due to its technical feasibility, high investment costs and long development time. Most of that one skilled in the area states that, likely, it will not be available before 2050.

The other types of reactor generate nuclear fusion at inexpressive rates (e.g., Cold Fusion) or consume more energy than they produce (e.g., Laser Fusion).

Most of the conventional reactors, e.g. Tokamak, usually are designed to fuse a mix of deuterium and tritium, which gives off 80% of its energy in the form of fast neutrons making the apparatus relatively radioactive. The energy of fast neutrons is collected by converting their thermal energy to electric energy, which is very inefficient (less than 30%).

The Field-Reversed Configuration or Magnetic Mirror Reactor have an unburned fuel leakage problem and the method of direct energy conversion to electricity (e.g.: U.S. Pat. Nos. 6,628,740, 6,664,740 and 6,888,907), although the best at moment, is relatively very complex and inefficient.

The Farnsworth-Hirsch Fusor (U.S. Pat. Nos. 3,258,402, 3,386,883, 3,530,036, 3,530,497, 3,533,910, 3,655,508 and 3,664,920) take advantage of electrostatic acceleration consuming low energy to reach great kinetic energy about 170 KeV (2 billion ° C.) against 10 KeV (100 million ° C.) of Tokamaks which uses inefficient methods like ohmic heating. The Farnsworth-Hirsch Fusor, which relies on electrostatic fields for acceleration and confinement, has an unsolvable grid-loss problem, where injected ions form a positively charged cloud around the negative central grid obstructing the remaining of positive ions to reach full kinetic energy leading to a saturation of the reactor.

The magnetic cusps is a common technology among some plasma confinement devices: Magnetic well for plasma confinement (U.S. Pat. No. 4,007,392), Multicusp plasma containment apparatus—Limpaecher (U.S. Pat. No. 4,233,537), Plasma confining device (U.S. Pat. No. 4,430,290), Bussard Polywell (U.S. Pat. No. 4,826,646) and others.

The Bussard Polywell (U.S. Pat. No. 4,826,646) is similar to the Multicusp plasma containment apparatus—Limpaecher (U.S. Pat. No. 4,233,537) in injecting charged particles through magnetic cusps.

The Bussard Polywell (U.S. Pat. No. 4,826,646—Oct. 29, 1985) wherein method steps, in summary, are generating magnetic cusps, injecting electrons through the magnetic cusps to create a negative potential, injecting positively charged particles toward the negative potential, and maintaining the number of electrons greater than the number of positively charged particles. The required excess of electrons leads to a saturation of the reactor limiting its energy production, also the excess of electrons causes excessive electromagnetic radiation (bremsstrahlung) lowering the kinetic energy of the plasma decreasing the nuclear fusion rate.

In a summary, most of the current nuclear fusion reactor approaches have no technical feasibility; some of them are giant and expensive; most of them are relatively radioactive due of using exclusively deuterium-tritium as fuel; most of them consume more energy than it produces; some of them generate fusion at inexpressive rates; some of them are relatively very complex and inefficient; therefore, no practical solution and no foreseeable end in sight to a practical power plant for all of them at present moment.

### SUMMARY OF THE INVENTION

The present invention was made in view of the prior art drawbacks described above, and the object of the present invention is to provide a workable method and apparatus to fuse charged particles releasing more energy than it consumes in a way to become self-sustainable.

To solve the problem, the present invention provides an apparatus and method for confining and fusing charged particles. The charged particles comprise positive and negative ions from neutronic and aneutronic fuels. For confining radially the charged particles, at least two, preferably six, magnetic fields to form a cusp region for a continuous injection of charged particles. An electric field (first electric potential) at the cusp region for accelerating the charged particles during the injection, and an opposite electric field (second electric potential) for trapping longitudinally the charged particles allowing only charged products to escape. The charged products are worthwhile for spacecraft propulsion and direct electricity conversion. The electric field (second electric potential) acts as an electrostatic lens focusing (converging) the particles as they approach to it. The magnet, preferably comprised by independent winding groups, act as a set of magnetic lens achieving a best focal length. At the magnetic cusp region, the charged particles are confined by the magnetic reconnection phenomenon, and the continuous injection becomes the confinement more efficient yet. The electrostatic acceleration method can reach great kinetic energy, about 600 KeV (7 billion ° C.), at low energy consumption. The preferred embodiment achieves a true three-dimensional confinement plus a three-dimensional charged particles injection giving a higher probability of fusion reactions. Further comprising an elementary resonance method for increasing the fusion rate, a high efficient direct electricity conversion by neutralization process, and a system for recycling magnets bore heat energy for generating electricity, becoming self-sustaining.

### OBJECTS AND ADVANTAGES

Accordingly, it is an object of this invention to provide a method and apparatus for fusing charged particles releasing more energy than it consumes becoming self-sustaining.

It is a further object of this invention to provide a method and apparatus for confining radially charged particles in magnetic fields and trapping them longitudinally in electrostatic fields, allowing or not the charged products of nuclear fusion escape longitudinally overcoming the electrostatic fields, thereby represents a true three-dimensional confinement with an adequate escape mechanism.

It is still another object of this invention to provide a method or apparatus for fusing either positive ions or negative ions allowing a choice between reducing bremsstrahlung radiation and increasing energy production.

It is another object of this invention to provide a method for accelerating ions in an electrostatic way to reach great kinetic energy at inexpressive energy consumption.

It is another object of this invention to provide a preferred embodiment comprised by six magnets representing the true three-dimensional confinement plus a three-dimensional ion injection, and a basic embodiment comprised by two magnets representing the true three-dimensional confinement plus a bi-dimensional ion injection.

It is another object of this invention to provide a method and apparatus for converting energy of charged products from aneutronic nuclear fusion directly to electricity with efficiency exceeding 95%.

It is another object of this invention to provide a method and apparatus for focusing the charged particles by a set of built-ins magnetic lens increasing fusion rate.

It is another object of this invention to provide an elementary resonance method for increasing fusion rates by oscillations on magnetic flux transferring energy radially to plasma and by oscillations on confinement electric voltage transferring energy longitudinally to plasma, the elementary resonance plus the escape mechanism and keeping plasma in a quasi-neutral state solve the saturation problem.

It is another object of this invention to provide a method and apparatus allowing a multidirectional energy flow which can, for example, be used to recycle energy stored in magnets back to a battery bank.

It is another object of this invention to provide a method and apparatus for bending exhausting charged products from nuclear fusion which will be useful for spacecraft propulsion.

It is another object of this invention to provide a method and apparatus for cooling the magnets and recycling its heat energy for electric energy generation using a steam turbine, a coolant, a condenser, a heat sink, a pump and an electrical generator.

It is another object of this invention that the method and apparatus are able to fuse aneutronic fuels, in special boron hydrides and helium-3, which represents low radiation hazards and efficient conversion of their charged products to electricity.

It is another object of this invention to provide a workable nuclear power plant suitable for a feasible spacecraft.

It is another object of this invention to provide consistent calculations to consolidate its technical feasibly.

It is another object of this invention to provide an example of bore coating capable to reflect back to plasma most of the electromagnetic radiation (bremsstrahlung) recycling its energy and increasing the fusion rate and keeping low the bore temperature.

These and other objects and features of the invention will become apparent from the following description in connection with the appended drawings illustrating preferred embodiment of the invention. It is to be understood, however, that these are given by way of illustration and not of limitation and that changes may be made in the detailed construction, materials, form and size of the parts, without affecting the scope of the invention.

### DRAWINGS FIGURES

FIG. 1 is an illustration of a basic embodiment comprised of two magnets, core electrical insulators and a circular ion injection belt;

FIG. 2 is an illustration of a preferred embodiment comprised of six magnets, core electrical insulators and an arc-shaped ion injection belt;

FIG. 3 is a cross-section taken of one the magnets of FIG. 2 to clarity the injection openings and the preferred windings;

FIG. 4 is an illustration of the preferred embodiment of FIG. 2 further including an armature, magnet bending, output insulator, with a partially exploded view to clarify the assembly;

FIG. 5 is an illustration of the preferred embodiment of FIG. 4 further including a fuel reservoir and a base;

FIG. 6 is an illustration of the preferred embodiment of FIG. 5 hiding magnet bending, insulators in order to show an electrical transformer, battery bank, a heat exchanger and a vacuum system;

FIG. 7 is an illustration of the electrical transformer having a multidirectional energy flow;

FIG. 8 is an illustration of the heat exchange system used for recycling heat energy from magnets;

FIGS. 9A and 9B is an illustration of an exploded assembly view of the preferred embodiment;

FIG. 10 is an illustration of a spacecraft comprised by the base, landing pads, hull, MPD thruster and output covering;

FIG. 11 is an illustration of the alternative embodiment of FIG. 1 further including an armature, output electrical insulators and output covering;

FIG. 12 is an illustration of the alternative embodiment of FIG. 11 further including a fuel reservoir and a base;

FIG. 13 is an illustration of an electronic schematic diagram used in explaining the multidirectional energy flow and the electricity conversion.

### REFERENCE NUMERALS IN DRAWINGS

| | |
|---|---|
| 1 | magnet |
| 2 | magnet |
| 3 | circular injector belt |
| 4 | ion injector |
| 5 | core insulator |
| 6 | core insulator |
| 7 | bolt |
| 8 | cold coolant inlet |
| 9 | magnet |
| 10 | core insulator |
| 11 | bolt |
| 12 | arc-shaped injector belt |
| 13 | cold coolant inlet |
| 14 | hot coolant outlet |
| 15 | winding groups |
| 16 | injector openings |
| 17 | magnet bore |
| 20 | armature |
| 21 | hot coolant pipe |
| 22 | bolts |
| 23 | magnet bending |
| 24 | cold coolant pipe |
| 25 | neutralizer top |
| 26 | output insulator |
| 27 | deflector |
| 28 | neutralizer middle |
| 29 | neutralizer bottom |
| 30 | neutralizer top |
| 31 | optical fiber |
| 32 | neutralizer bottom |
| 33 | magnet bending |
| 34 | output insulator |
| 35 | optical fiber |
| 36 | electrical transformer |
| 37 | vacuum pump |
| 38 | fuel reservoir |
| 39 | base |
| 40 | air breathing |
| 41 | landing pad |
| 42 | battery bank |
| 43 | steam turbine |
| 44 | output covering |
| 45 | low voltage power supply |
| 46 | acceleration power supply |
| 47 | confinement power supply |
| 48 | cold coolant pipe |
| 49 | hot coolant pipe |
| 50 | electrical generator |
| 51 | condenser |
| 52 | cold pipes branching |
| 53 | hot pipes merging |
| 54 | MPD thruster |
| 55 | spacecraft hull |
| 56 | air breathing |
| 57 | exhaust output |
| 60 | extra insulator |
| 61 | output insulator |
| 62 | extra confinement |
| 63 | armature |
| 64 | neutralizer top |
| 65 | neutralizer middle |
| 66 | neutralizer bottom |
| 67 | output covering |
| 68 | deflector |
| 69 | electrical transformer |
| 70 | steam turbine |
| 71 | base |
| 72 | air breathing |
| 73 | landing pad |
| 74 | ground wire |
| 80 | optical fiber |
| 81 | control system |

### DESCRIPTION OF INVENTION

In the following will be described at least two different practical workable embodiments of this invention.

### Preferred Embodiment

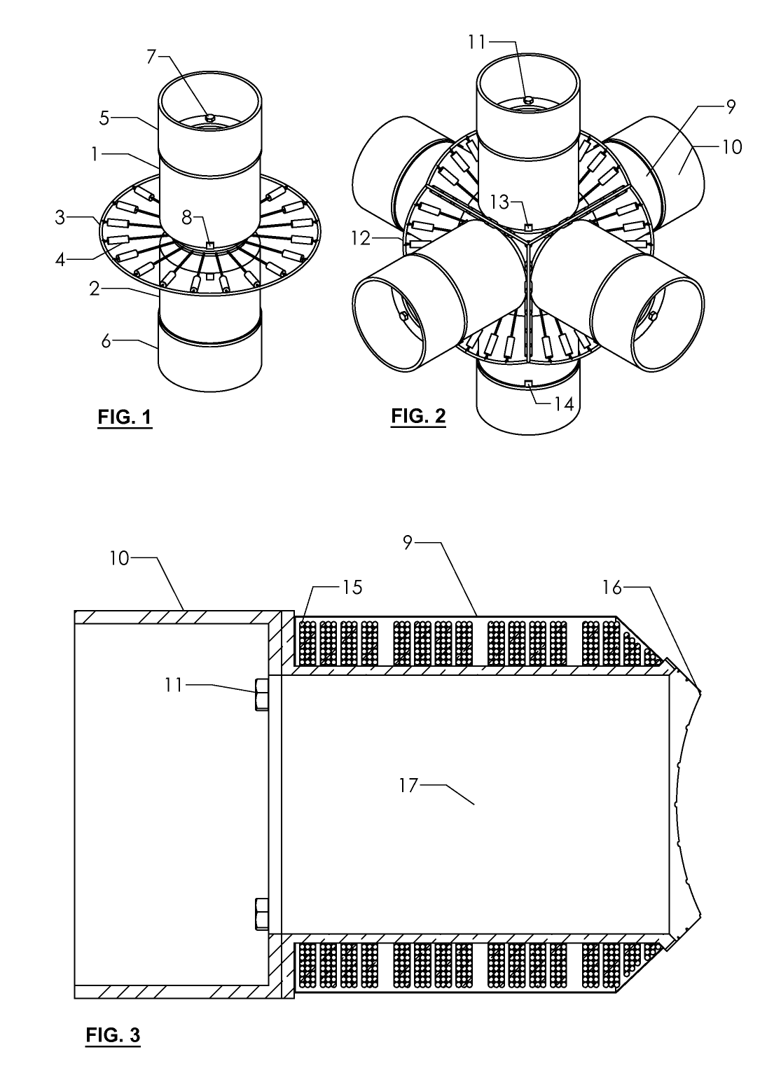

A preferred embodiment, comprised by six magnets, is shown in FIG. 2, however, for a better understanding, a basic embodiment, comprised by two magnets, is shown in FIG. 1, in where is illustrated a magnet 1 and a magnet 2 joined forming an angle of 180° between each other, and a circular ion injector belt 3 with the output of its ion injectors 4 between the intersection (region of magnetic cusps). The circular injector belt 3 is comprised by twenty ion injector 4 disposed concentrically and equally spaced around the intersection of the magnets. An electrical insulator 5 is attached to magnet 1 and an electrical insulator 6 is attached to magnet 2, both by four bolts each one (see bolt 7).

The ideal structure is illustrated in FIG. 2 in where there are six magnets, each one similar to magnet 9, joined forming angles of 90° at adjacencies, and an arc-shaped injector belt 12 with the output of its ion injector between the intersections (region of magnetic cusps). The arc-shaped injector belt 12 is comprised by twelve arcs of arccos (⅓)≈70.52878°, and by sixty eight ion injectors disposed concentrically and equally spaced around the intersection of the magnets. An electrical insulator 10 is attached to magnet 9 by four bolts (see bolt 11), similarly to others set of magnet and electrical insulator. A cold coolant inlet 8 (FIG. 1), a cold coolant inlet 13 and a hot coolant outlet 14 belongs to a heat exchange system and will be further explained. The intersection of two or more magnets bore forms the reactor chamber.

In the ion injector 4, several types of ion sources can be used (e.g., RF ion source due to its long life), however, it is preferably a duoplasmatron ion source having a low beam angle dispersion in order to produce either positive or negative ions in a well focused beam. A measurement of electron current between the ion source and the ground electric potential (common electric potential), using a conventional ammeter plus a fuel flow meter, can be used to determine specific ionization of the plasma. The output of the ion injector is comprised by an electrical insulated material preferably boron nitride. In case of using solid fuels, like decaborane (200° C.), then a pre-heating mechanism must be provided for heating the fuel until it vaporizes. Both the circular injector belt 3 and arc-shaped injector belt 12 can have its ion injectors as described above.

The magnet coils can be wound as a conventional magnet in a single multilayer winding of enameled copper wire, however, FIG. 3 illustrates a cross-section taken of magnet 9 to clarity a preferred winding 15 in where is comprised by multiple flat pancake coils (sixteen as illustration) coaxially disposed along the longitudinal axis of the magnet. The flat pancake coils are grouped, preferably in four groups, having each group an independent electrical current source in order to be acting as an independent magnetic lens. A superconducting magnet winding is preferably, typically niobium-titanium (e.g., multifilamentary NbTi copper in epoxy), niobium-tin or copper oxide ceramics (e.g., YBCO, TBCCO, HgBCCO, BSCCO), cooled below a critical temperature by liquid helium, performing a magnetic flux of 4.5 Tesla or better, at low power consumption. A magnet bore 17 is preferably coated with a hard and dense metal alloy, tungsten or depleted uranium covered by a layer of a dielectric material like silicon dioxide or titanium dioxide, in order to reflect electromagnetic radiation keeping low the bore temperature, and more preferably that the coating be done in an electrical insulated annular way or using a powder compound of the metal alloy in order to keep an electrical insulation along the longitudinal axis of the magnet, thereby a voltage produced by inductive reactance of the pancake coils, due to an electrical current variation, can be transferred axially to plasma. Magnet 1 can be done in some way as magnet 9, only differing on openings 16 for the ion injectors and shape of the intersections. The magnets intersection (region of magnetic cusps) is where an acceleration electric potential (first electric potential) is applied.

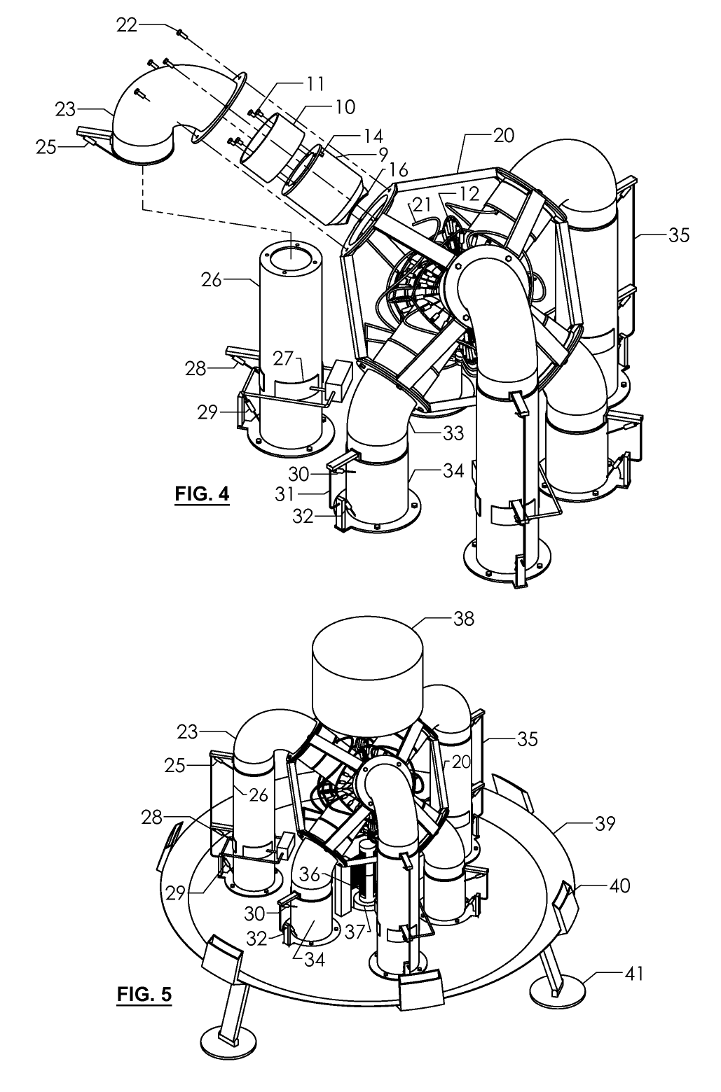

A continuation of the preferred embodiment of FIG. 2 is shown in FIG. 4, further illustrating a partial assembly view (lines of mounting shown as dashed lines) in where the magnet 9 is connected to the electrical insulator 10 by bolts 11. A magnet bending 23 fastened by bolts 22 to an armature 20, fixing the insulator 10 by pressing it inward the armature. The armature, preferably a metal alloy like titanium or stainless steel, sustains the six magnets and its respective electrical insulators, and the magnets are pressed to sustain each other at the intersection region. The assembly described above is repeated, equally spaced at an angle of 120° to the others magnet bending top 23 and as well to a magnet bending bottom 33 equally spaced at angle of 120° to the others magnet bending bottom, where magnet bending top and magnet bending bottom are in an angle of 60°. The armature 20 keeps the reactor components together, providing support to magnets, insulators, ion injector belt 12 and bending magnets. The armature is where a confinement electric potential (second electric potential) is applied.

The magnet bending is useful to bend the exhausting products of nuclear fusion, the magnet bending top 23 has a bending angle of (90°+(arccos (⅓)/2))≈125.26439°, and the magnet bending bottom 33 has a bending angle of (90°−(arccos (⅓)/2))≈54.73561°. The magnet bending coils can be a single multilayer superconducting magnet winding, much simpler than aforesaid for magnet 9.

Continuing with the embodiment shown in FIG. 4 in where each magnet bending top 23 is connected to an output electrical insulator 26, as well each magnet bending bottom 33 is connected to an output electrical insulator 34. An electrostatic deflector 27 comprised by three plates disposed around the output electrical insulator 26 is to deflect the charged products in order to align its trajectory giving some steering. A hot coolant pipe 21 belongs to a heat exchange system and will be further explained. The neutralizers 25, 28, 29, and 32 are electrons guns and duoplasmatron ion sources used for electricity conversion by neutralization process and will be further explained. An optical fiber top 35, as well an optical fiber bottom 31, is to control and monitor the neutralizers and other components of the reactor which are at different electric potential, thereby optical fiber is preferably due to its high electrical insulation and immunity to an electromagnetic interference.

The electrical insulators for the present invention can be made from several materials types like polytetrafluoroethylene (60MV/m), acrylic glass, ceramic, porcelain, nylon (14 MV/m), polyester, polystyrene (24MV/m), neoprene rubber (12MV/m), but the two recommended is boron nitride due to its excellent thermal properties and a dielectric strength of 6MV/m, and the polycarbonate due to its physics properties and dielectric strength of 15MV/m.

A continuation of the preferred embodiment of FIG. 4 is shown in FIG. 5, further illustrating a fuel reservoir 38, preferably made of graphite-epoxy or carbon fiber reinforced plastic. An electrical transformer 36, and below that a vacuum pump 37, preferably an oil diffusion pump or better, to keep the whole reactor system, preferably including electric and electronic components, in a very low pressure of 10⁻⁶ Torr or lower, in order to provide a high electrical insulation of a dielectric strength of 1GV/m, meaning an optimum short circuit preventing. A base 39 is preferably an aluminum alloy to act as a heat sink. The output electrical insulators 26, 34 and so forth are fixed on the base. An air breathing 40 and a landing pad 41 are parts of a spacecraft and will be further described.

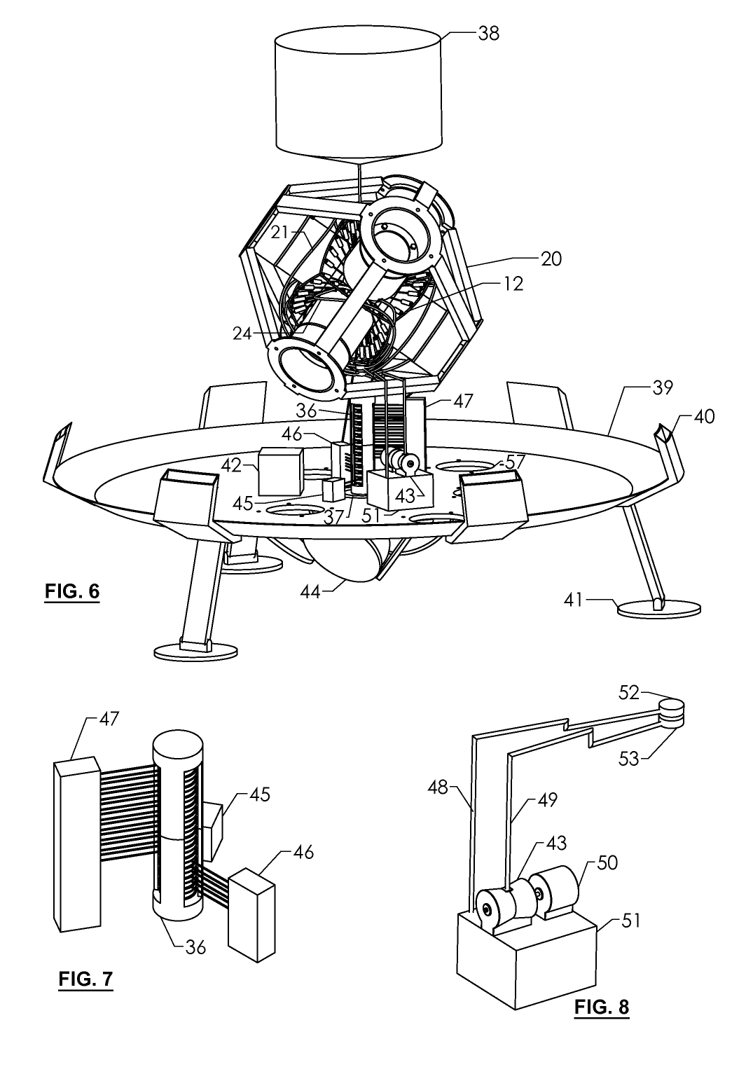

A continuation of the preferred embodiment of FIG. 5 is shown in FIG. 6, hiding the magnet bending, output insulators and so on, for illustrating electrical transformer 36, and below that the vacuum pump 37, and further illustrating a battery bank 42, preferably comprising a hydrogen fuel cell. A heat exchange system 43 and a cold coolant pipe 24. An output covering 44 and an exhaust output 57 will be further described.

The electrical transformer 36 is illustrated in FIG. 7, better illustrating a low voltage power supply 45 of about 250 Volts, an acceleration power supply 46 (first electric potential), and a confinement power supply 47 (second electric potential). The power supplies have a custom bidirectional switching-mode full bridge mosfet technology. The electrical transformer windings no overlap each other, primary and secondary windings are defined dynamically allowing a multidirectional energy flow as will be further described.

The heat exchange system is illustrated in FIG. 8, in where a coolant, preferably liquid helium due to its low tendency to absorb neutrons, circulates towards a branching 52 by a pipe 48, then towards a magnet coolant inlet 13 (FIG. 2) by a pipe 24 (FIG. 6). The heated coolant circulates from a magnet coolant outlet 14 (FIG. 2) towards a merging 53 by a pipe 21 (FIG. 4), then to a steam turbine 43 by a pipe 49, and then to a conventional internal serpentine of a condenser 51. The steam turbine rotates and transfers its mechanical energy to an electrical generator 50 recycling the heat excess to electricity. The condenser 51 transfers the remaining heat excess to the base 39 (FIG. 6) which is acting as a heat sink. A condenser internal pump circulates the coolant from the serpentines toward the pipe 48 continuing the cycle. The liquid helium, for superconducting magnet requirements, must be cooled down to temperatures of approximately 4.2 Kelvin.

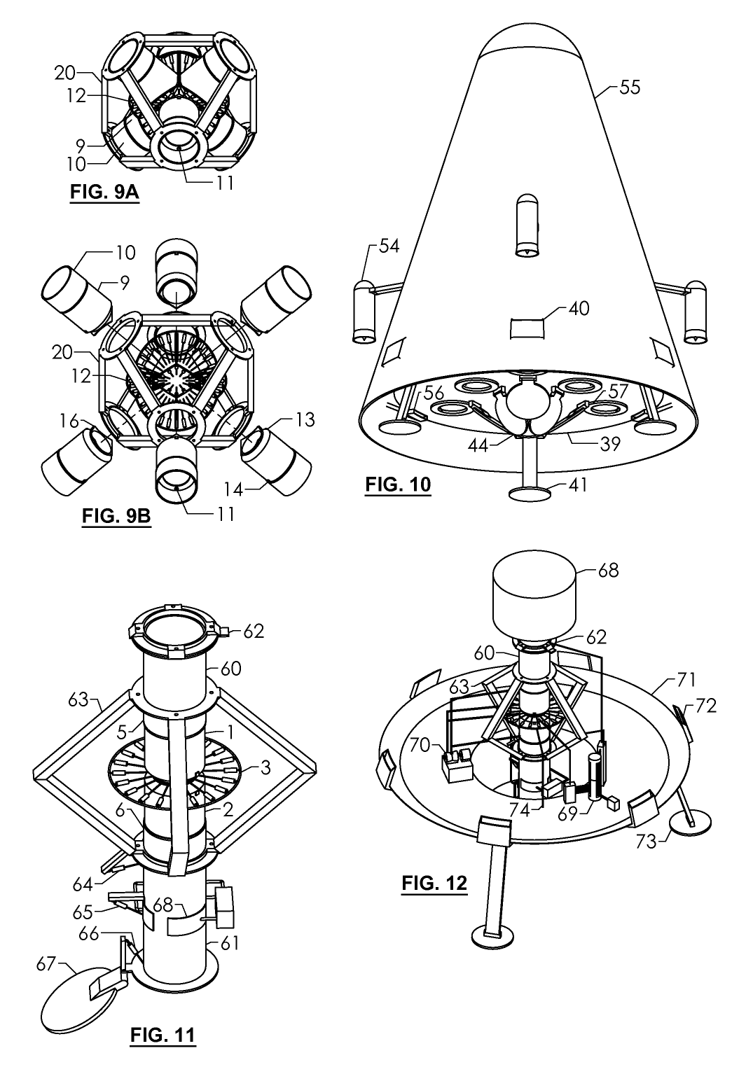

A continuation of the preferred embodiment of FIG. 2 is shown in FIG. 9A and an exploded assembly view is shown in FIG. 9B (lines of mounting shown as dashed lines), illustrating arc-shaped injector belt 12 and armature 20, in order to clarify the assembly of the set of magnet 9, electrical core insulator 10, one of the bolts 11, the openings 16 for the ion injectors, cold coolant inlet 13 and hot coolant outlet 14. The six magnet assemblies will sustain each other concentrically to the arc-shaped injector belt by being pressed against the armature by the magnets bending already described in FIG. 4. The magnets intersection (region of magnetic cusps) is where the acceleration electric potential (first electric potential) is applied. The armature 20 is where the confinement electric potential (second electric potential) is applied. The ion injectors exchange its electrons with the ground electric potential (common electric potential) to ionize the nuclear fusion fuel.

A spacecraft (weigh: 500000 Kg, height: 22 m, diameter: 15 m) using the preferred embodiment of FIG. 5 as power plant is shown in FIG. 10, in where three landing pads 41 are equally spaced at an angle of 120° to sustain the base 39 which sustain a hull 55, preferably made of an aluminum alloy of at least 10 cm of thickness to protect against outer space radiation. Three electric thrusters 54, preferably a magnetoplasmadynamic (MPD) thruster, positioned near the center of mass of the spacecraft or a little above and disposed around the hull equally spaced at an angle of 120°. The electric thruster is preferably moveable around its axis in order to give some steering for stabilization during the launching, re-entry and landing, and some maneuverability in the space. The MPD thrusters must operate during short periods due to its low lifetime. To keep the spacecraft aligned straight ahead for a long time is used the electrostatic deflector 27 as already described in FIG. 4. A six output covering 44 is to cover the six exhaust output 57 during startup of the reactor in order to maintain the vacuum, after the reactor startup, all six outputs covering open letting the products of nuclear reaction, already neutralized by neutralizers, thrust the spacecraft. An air breathing 40, 56, there are six disposed equally spaced around the base at angle of 60°, is to increase the reaction mass when the spacecraft is in an atmospheric environment doing the products of the nuclear reaction heat incoming atmospheric gases expanding it to give more thrusting for the spacecraft. The landing pads 41 are preferably moveable or retractile in order to reduce the aerodynamic drag.

### Alternative Embodiment

A continuation of the basic or alternative embodiment of FIG. 1 is shown in FIG. 11, further illustrating an armature 63 which keeps the reactor components together, providing support to core insulator 5 and 6, magnet 1 and 2, circular ion injector belt 3. The magnets intersection (region of magnetic cusps) is where the acceleration electric potential (first electric potential) is applied. The armature is where a confinement electric potential (second electric potential) is applied. An extra confinement insulator 60 and a disc 62 are for applying an extra confinement electric potential in order to confine both reactants and products of the nuclear fusion reaction at the top end. The products can only escape at bottom end passing by output insulator 61. An electrostatic deflector 68 comprised by three plates disposed around the output electrical insulator 61 is to deflect the charged products to align its trajectory. The neutralizers 64, 65 and 66 are electrons guns and duoplasmatron ion source used for electricity conversion by neutralization process. An output covering 67 is to cover the exhaust output during startup of the reactor in order to maintain the vacuum. Most of the components are similar to that already cited in FIG. 4, except that there is only one output.

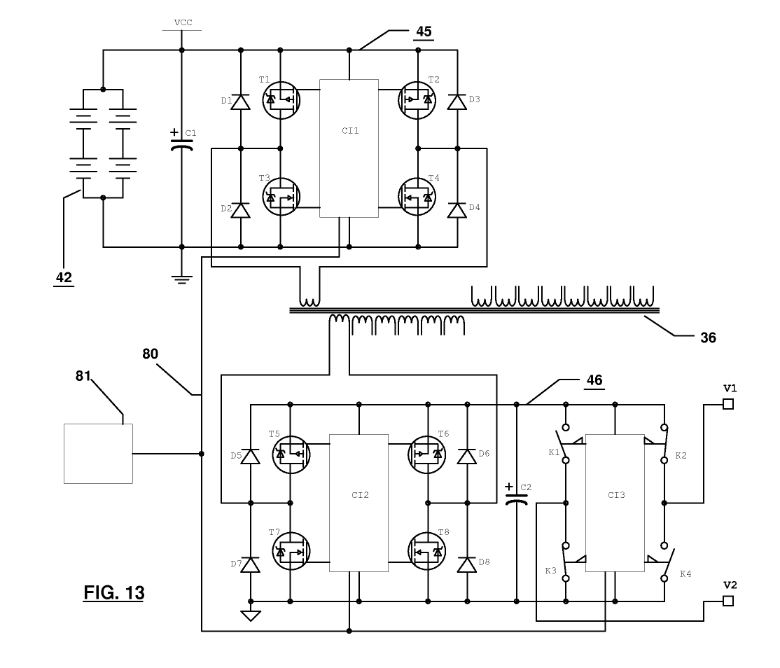

A continuation of the alternative embodiment of FIG. 11 is shown in FIG. 12, further illustrating a fuel reservoir 68 similar to that previously described in FIG. 5. A base 71 is preferably an aluminum alloy to act as a heat sink. An electrical transformer 69 similar to that previously described in FIG. 7 except that there are an extra electrical voltage for apply an electric potential at disc 62 providing the extra confinement in one of the ends. A heat exchange system 70 similar to that previously described in FIG. 8, an air breathing 72 and a landing pad 73 are similar to that previously described in FIG. 10. A ground wire 74 (common electric potential) for the ion injectors exchange its electrons for ionizing the nuclear fusion fuel. Most of the components are similar to that already cited for the preferred embodiment.

### Operation of Invention

A basic operation can be better understood from the FIG. 1 in where magnet 1 and magnet 2 generates a magnetic field of same polarity, preferably south, at the intersection between them forming magnetic cusps. The acceleration electric potential (first electric potential) is applied at the region of magnetic cusps. The confinement electric potential (second electric potential), of opposite polarity to the first, is applied to armature 63 (FIG. 11) generating electric fields. The electrical insulators 5 and 6 provide an electrical gap between the armature and the magnets.

For trapping positively charged particles (positive ions) the acceleration electric potential (first electric potential) must have a negative voltage, and the confinement electric potential (second electric potential) must have a positive voltage. Otherwise, for trapping negatively charged particles (negative ions) the acceleration electric potential (first electric potential) must have a positive voltage, and the confinement electric potential (second electric potential) must have a negative voltage. The confinement electric potential can be adjusted for trapping only the reactants allowing the charged products of the nuclear fusion to escape longitudinally overcoming the confinement electric potential.

The ion injectors 4 of the circular injector belt 3, ionizes a nuclear fusion fuel exchanging electrons with the ground electric potential (common electric potential), and the ionized fuel, that is charged particles or ions, is accelerated in a electrostatic way towards the intersection (region of magnetic cusps) reaching the interior of the magnets after passing through the region of magnetic cusps. The charged particles become confined radially by magnetic fields and trapped longitudinally along the axis of the magnets by the electric fields generated by the first and second electric potentials. The armature electric fields, of same polarity of the charged particles, act as an electrostatic lens focusing (converging) the particles as they approach to it and defocusing (diverging) them as they move away from it. The magnetic fields act as a magnetic lens focusing (converging) the charged particles. If the magnets are similar as the previously described in FIG. 3, comprising of a set of independent winding groups, then each group can have its electric current varied independently from the others in order to change the magnetic flux shaping the magnetic field to achieve a best focal length increasing the fusion rate.

The charged particles move longitudinally describing a circular and helical orbit around the magnetic field lines keeping away from the magnet walls. At the region of the magnetic cusps, the magnetic field lines are curved forcing the charged particles to describe a more elliptical and eccentric orbit increasing electrostatic pressure at the region of the magnetic cusps creating a great difficulty to them to escape overcoming this region (magnetic reconnection phenomenon), and the continuous injection of the charged particles by the ion injector belt become it more difficult yet.

The charged particles are confined radially by magnetic fields and trapped longitudinally by first and second electric field in the interior of the magnetic fields and confined by magnetic cusp by magnetic reconnection phenomenon, until the charged particles fuse and their charged products may escape longitudinally overcoming the second electric field. Thereby represents a true three-dimensional confinement with an adequate escape mechanism.

Inducing variations preferably by pulses on electrical current of the magnets results in oscillations on magnetic flux transferring radially energy to plasma (pinch effect) increasing the fusion rate.

If the magnets are similar as the previously described in FIG. 3, coated with a hard and dense metal alloy, tungsten or depleted uranium, then most of the electromagnetic radiation (bremsstrahlung) can be reflected back to the plasma recycling its energy increasing the fusion rate. If the coating is done in an electrical insulated annular way or using a powder compound of the metal alloy in order to keep an electrical insulation along the longitudinal axis of the magnet, and if the magnet windings are comprised by multiple flat pancake coils (FIG. 3), then a voltage produced by inductive reactance of the pancake coils, producing an alternating electric field in the bore due to an electrical current variation, can be transferred axially to the plasma increasing a little more the fusion rate.

Inducing oscillations on electric voltage of the first or second potentials, preferably both, most of the energy of the electric oscillations will be transferred longitudinally to the charged particles increasing the fusion rate.

The oscillations described above can be comprised by a modulation and multiplexing of frequencies: a cyclotron rotation at frequency ω₊, a magnetron rotation at frequency ω₋, and an axial “trapping” oscillation at frequency ω_{z}. The higher frequency is the cyclotron that can be estimated f=qB/(2πm), and the others is by measuring energy production and adjusting the oscillations to reach a maximum synchronization of phase and frequency with the plasma resulting in an increase of the fusion rate. For that, can be a conventional RF generator via a pulse transformer connected in series with the power supplies. Adjusting and measuring the energy production is a simple way to determine the frequencies and can be understood as an elementary resonance method. An excess of electric charge in the reactor chamber can lead to a saturation wasting fuel and reducing the energy production, however, using oscillations for increasing the fusion rate will decrease the electric charge in the reactor chamber allowing injection of more of the charged particles increasing the energy production.

Thoughtfulness about the preferable polarity of the magnetic fields at the intersection between the magnets forming the magnetic cusps region: an electric current on magnet windings develops an electric voltage on its terminals due to resistivity, and a pulse, positive or negative, on electric current develop an electric voltage on its terminals due to inductive reactance. The electric voltage due to resistivity can be too little to take some advantage. Thus the magnetic south polarity is only a predilection, but could be magnetic north polarity if desirable.

The most efficient method of transferring kinetic energy to the charged particles is by electrostatic acceleration, doing this from a ground potential (common electric potential) and allowing the charged particles fall to the acceleration electric potential (first electric potential) exchanging its potential energy to kinetic energy, represents great kinetic energy at low energy consumption (P=V×I; V=0→P=0). A measurement of electron current between the ion source and the ground electric potential can be used to determine specific ionization of the plasma. A duoplasmatron is one of the ion sources that can be used in the ion injector 4, and its advantage is to produce either positive or negative ions. For ionizing the nuclear fusion fuels to the positively charged particles is by extracting electrons from them and sending electrons to the common electric potential, otherwise for ionizing to the negatively charged particles is by extracting electrons from the common electric potential and adding the electrons to the nuclear fusion fuel.

Fusing positively charged particles represents a normal energy production and low bremsstrahlung radiation, otherwise fusing negatively charged particles represents a high energy production and high bremsstrahlung radiation, however, for a highest energy production, the specific ionization must keep as low as possible, that is the plasma charged particles must be a quasi-neutral plasma resulting in a high density, which implies in a higher magnetic flux and a higher acceleration and confinement voltage, as will be further understood by calculations.

The nuclear fusion fuel can be composed of light atomic nucleus like hydrogen, deuterium, tritium, helium, lithium, beryllium, boron, and their various isotopes. Some isotopes like hydrogen-1, helium-3, lithium-6, lithium-7 and boron-11 are the interest for aneutronic nuclear fusion (low neutron production), in special boron hydrides and helium-3. The fuel specific energy and specific ionization are essential for dimensioning the magnet bore, magnetic flux and electric voltages, as will be further understood by calculations.

The injector belt 3 of the basic embodiment (FIG. 1) injects the charged particles only in radial ways, representing a bi-dimensional ion injection plus the true three-dimensional confinement. The injector belt 12 of the preferred embodiment (FIG. 2) injects the charged particles in three orthogonal axes, representing a three-dimensional ion injection plus the true three-dimensional confinement, having higher probability of fusing atomic nucleus.

The six magnet bending 23 and 33 is useful to bend the exhausting products of the nuclear fusion, as previously described for the preferred embodiment in FIG. 4. The alternative embodiment (FIG. 11), comprised by two magnets, dispense the magnet bending, but require an extra confinement potential in order for the exhausting charged products escape through only one of its ends, however, it increases the probability of secondary reactions. The preferred embodiment (FIG. 4) can have its three magnet bending top 23 suppressed and applied an extra confinement electric potential, then the charged products can only escape by its others three magnet bending 33, this can simplify the assembly but increase the secondary fusion reactions meaning more radiation hazards. Thus, more output for the charged products will result less the undesirable secondary fusion reactions.

The base 39 (FIG. 5), as well 71 (FIG. 12), is connected to the ground electric potential (common electric potential). The output electrical insulators 26 and 34 (FIG. 5), as well 61 (FIG. 11), is to provide an electrical insulation between the armature and the base. Surrounding the outputs there are the electrostatic deflector plates 27 (FIG. 5), as well 68 (FIG. 11), to deflect the charged products in order to align its trajectory giving some steering.

The neutralization is essential to prevent that the charged products, after passing through the outputs, turn around and collide back eroding the base and others components, for that, the sum of the electron current of the neutralizers 25, 28, 29, 30, 32 and so forth (FIG. 5) must be equaled to the sum of the electron current of the ion injector belt 12 (FIG. 2). This rule must be applied for the neutralizers 64, 65, 66 and so forth (FIG. 11) and the circular injector belt 3. The electricity conversion by neutralization process will be further explained.

A special power supply system is required to generate voltages for the acceleration electric potential (first electric potential), the confinement electric potential (second electric potential), and for the other components of the nuclear fusion reactor. Its main feature is to allow a multidirectional energy flow used to recycle energy stored in magnets (E=½LI²) and capacitors (E=½CV²) back to a battery bank or to the others power supplies.

A continuation of the FIG. 7 is illustrated as an electronic schematic diagram in FIG. 13 to clarity the multidirectional energy flow, in where the battery bank 42 and a capacitor C1 has electric energy stored, circuit CI1 switches between on and off states the MOSFET transistors T1 and T4, T2 and T3, alternating the electric current to the electrical transformer 36. The diode bridge, comprised by diodes D5 and D8, D6 and D7, convert the alternating electric current from transformer 36 to direct current to supply a capacitor C2 storing the energy in it. This process is well known in a conventional switching-mode power supply having a full bridge technology using either MOSFET or IGBT transistors.

The energy stored in capacitor C2 can be sent back to battery bank 42 and capacitor C1 if circuit C12 switches between on and off states the MOSFET transistors T5 and T8, T6 and T7, alternating the electric current to the electrical transformer 36, and the diode bridge, comprised by diodes D1 and D4, D3 and D2, convert the alternating electric current from transformer 36 to direct current to supply battery bank 42 and capacitor C1 restoring the energy to it.

The power supplies 45 and 46 have a bidirectional energy flow between them, the transformer 36 have others power supplies attained to it, and, with a suitable control, perform the multidirectional energy flow.

To invert the output polarity of the power supply 46, worthwhile for confining and fusing either positively or negatively charged particles from a duoplasmatron ion source, a circuit CI3 switch on the relays K2 and K3, and switch off the relays K1 and K4, then the terminal V1 have a positive voltage relative to V2, otherwise will have a negative voltage.

To achieve high voltages for acceleration and confinement potentials, several power supplies, similarly as described above, must be connected in series from the ground electric potential (common electric potential). Some power supplies have a high electric voltage between them (millions Volts). For that, and to control and monitor the whole system, an optical fiber 80 is the most recommended due to its high electrical insulation and immunity to an electromagnetic interference. The control system 81 controls and monitors the power supplies and other reactor components via the optical fiber 80, as well 31 and 35 (FIG. 4), using a semi-duplex protocol.

Before explaining the electricity conversion from the charged products, is useful to remember some physics electric concepts: extracting electrons from a positive terminal of a charged capacitor will increase its voltage and consequently increase its stored energy (E=½CV²), otherwise extracting electrons from a negative terminal of the charged capacitor will decrease its voltage and consequently decrease its stored energy. Another way to think is allowing electrons towards to the positive terminal of the charged capacitor will decrease its voltage and consequently decrease its stored energy (E=½CV²), otherwise pushing electrons towards to the negative terminal of the charged capacitor will increase its voltage and consequently increase its stored energy.

The method of converting kinetic energy from charged products in electricity is by neutralization process, where neutralizer particles comprise either electrons or positive ions. If the products of the nuclear fusion reaction are positively charged then the positive confinement electric potential forces the positively charged products to exchange its kinetic energy to potential energy, and the positively charged products attract easily electrons from the neutralizer 25 (FIG. 4) which is at the positive confinement electric potential. The electron extraction from the positive potential will increase the voltage of the capacitor C2 of the switching-mode power supply (similar to FIG. 13). The charged products lose kinetic energy and will not reach full acceleration to the ground electric potential after being neutralized. The circuit CI2 can send the energy received from the charged products to the transformer 36 allowing the flow of electrons from its ground to reduce the positive voltage, for that must switch its transistors, as previously described in FIG. 13, sending excess of energy to the electrical transformer, and the power supply 45 can receive the energy by its diode bridge and then supply the battery bank 42 or other power supply. The whole process is controlled, in a synchronized mode, by the control system 81. The received electric power is calculated by formula: P=V×I, that is, the electric potential versus flow of electrons equals to the energy flow received from the charged products.

Otherwise, if the products of the nuclear fusion reaction are negatively charged then the negative confinement electric potential forces the negatively charged products to exchange its kinetic energy to potential energy, and the negatively charged products attract easily positive ions from the neutralizer 25 (FIG. 4), preferably a duoplasmatron, which is at the negative confinement electric potential. The neutralizer electrons pushed towards to the negative potential will increase the voltage of the capacitor C2 of the switching-mode power supply (similar to FIG. 13). The charged products lose kinetic energy and will not reach full acceleration to the ground electric potential after being neutralized. The energy stored in the capacitor C2 can be sent to others power supplies as previously described.

The method of transferring electric energy to increase the kinetic energy of the charged products is also by ion neutralization. This method is useful for spacecraft propulsion purposes like stabilization. If the products of the nuclear fusion reaction are positively charged then a negative electric potential, can be applied to the deflector 27 (FIG. 4), increasing the kinetic energy of the positively charged products, and the positively charged products attract easily electrons from the neutralizer 28 (FIG. 4) which is at the negative electric potential. The electron extraction from the negative potential will decrease the voltage of the capacitor C2 of the switching-mode power supply (similar to FIG. 13). The charged products gain more kinetic energy reaching an extra acceleration to the ground electric potential before being neutralized. The power supply 45 must send more energy to the power supply 46 via transformer 36 to restore the voltage of the capacitor C2. The transferred electric power is calculated by formula: P=V×I, as previously described.

Otherwise, if the products of the nuclear fusion reaction are negatively charged then a positive electric potential, can be applied to the deflector 27 (FIG. 4), increasing the kinetic energy of the negatively charged products, and the negatively charged products attract easily positive ions from the neutralizer 28 (FIG. 4), preferably a duoplasmatron, which is at the positive electric potential. The neutralizer electrons pushed towards to the positive potential will decrease the voltage of the capacitor C2 of the switching-mode power supply (FIG. 13). The charged products gain more kinetic energy reaching an extra acceleration to the ground electric potential before being neutralized. The power supply 45 must send more energy to the power supply 46 via transformer 36 to restore the voltage of the capacitor C2, similarly as previously described.

After accomplished desired conversions of energy as described above, which can excess 95% of efficiency using aneutronic fuels like boron hydrides and helium-3, the remaining of the charged products must be fully neutralized, for that, there are neutralizer like 29 and 32 (FIG. 4) at the ground electric potential. As previously described, the sum of the electron current of the neutralizers must be equaled to the sum of the electron current of the ion injector belt.

The heat exchange system, previously described in FIG. 8, can recycle the magnet bore heat energy, due to electromagnetic radiation, to generate electricity. It is also worthwhile for recycling heat energy from fast neutrons if using neutronic fuels like deuterium.

The operation of the alternative embodiment FIG. 11 and FIG. 12 are similar to the preferred embodiment.

### Calculations

As aforesaid, the nuclear fusion fuel for this disclosure can be composed of light atomic nucleus like hydrogen, deuterium, tritium, helium, lithium, beryllium, boron, and their various isotopes. Some isotopes like hydrogen-1, helium-3, lithium-6, lithium-7 and boron-11 are the interest for aneutronic nuclear fusion (low neutron radiation hazards), as example:

¹H+2⁶Li→⁴He+(³He+⁶Li)→3⁴He+¹H+20.9 MeV (153TJ/Kg≈42GWh/Kg)

¹H+⁷Li→2⁴He+17.2 MeV (204TJ/Kg≈56GWh/Kg)

³He+³He→⁴He+2¹H+12.9 MeV (205TJ/Kg≈57GWh/Kg)

¹H+¹¹B→3⁴He+8.7 MeV (66TJ/Kg≈18GWh/Kg)

Boron hydrides (plentiful in the Earth) and helium-3 (plentiful in the lunar regolith) are special aneutronic fuels, due to its primary reaction produce less than 0.2% of the total energy as fast neutrons, meaning that a minimum of radiation shield is required for a spacecraft, and the products kinetic energy is directly convertible to electricity with a high efficiency, more than 95%, as previously described.

With hydrogen, boron forms a series of chemical compounds called borane or boron hydrides, as example, decaborane (B₁₀H₁₄) which have low toxicity and high density (950 Kg/m³), and relatively inexpensive taking account that it is clean and its specific energy is higher than the fossil fuels (18×10⁶ KWh/Kg versus 13 KWh/Kg).

The following calculations take decaborane (B₁₀H₁₄) as example:

¹H+¹¹B+123 KeV→3⁴He+8.68 MeV (66TJ/Kg≈18GWh/Kg)

Electronvolt (eV) is a unit of energy and a Volt (V) is a unit of electric voltage.
Electronvolt to Joule: 1 eV=1.60218×10⁻¹⁹J
Electronvolt to temperature: 1 eV=11604.505 Kelvin→1 eV=11604.505 K−273.15=11331.355° C.
Electronvolt to mass: 1 eV=1.782662×10⁻³⁶ Kg→1 MeV=1.782662×10⁻³⁰ Kg
Charge: proton=+1.60218×10⁻¹⁹ C, electron=−1.60218×10⁻¹⁹ C
Particles mass: proton=1.67262×10⁻²⁷ Kg, neutron=1.67493×10⁻²⁷ Kg, electron=0.00091×10⁻²⁷ Kg
¹¹B mass=5 protons+5 electrons+6 neutrons=5×1.67262×10^{-27+5×0.00091×10}⁻²⁷+6×1.67493×10^{-27=18.41723×10}⁻²⁷ Kg
¹H mass=1 proton+1 electron=1×1.67262×10⁻²⁷+1×0.00091×10⁻²⁷=1.67353×10⁻²⁷ Kg
Decaborane (B₁₀H₁₄) mass: 10×18.41723×10⁻²⁷+14×1.67353×10⁻²⁷=207.60172×10⁻²⁷ Kg
Specific energy of decaborane (eV/Kg):

10×(8.68 MeV−123 KeV)/(207.60172×10⁻²⁷ Kg)=4.12183×10³² eV/Kg

Specific energy of decaborane (J/Kg):

4.12183×10³²×1.60218×10⁻¹⁹=66.03921×10¹² J/Kg

Specific energy of decaborane (GWh/Kg):

66.03921×10¹²/(3.6×10⁶)=18.34422×10⁶ KWh/Kg=18.34422 GWh/Kg

Extracting 14 electrons from decaborane to produce positively charged particles:

207.60172×10⁻²⁷−14×0.00091×10⁻²⁷=207.58898×10⁻²⁷ Kg

Specific ionization of decaborane (C/Kg) after extracting 14 electrons:

14×1.60218×10⁻¹⁹/207.58898×10⁻²⁷=+10.80525×10⁶ C/Kg

The specific energy and specific ionization are essential parameters to define the magnetic flux and electrical potentials.
Using the specific energy to find velocity of products from nuclear reaction:

E=½mv²→=((E/m)×2)^{0.5}→v=((66.03921×10¹² J/Kg)×2)^{0.5}→v=11.49254×10⁶ m/s

Specific impulse: 11.49254×10⁶/9.80665=1.17191×10⁶ s
Defining the magnet bore about 1 meter (0.5 meter of internal radius) and using the specific ionization to find magnetic flux:

r=mv/qB→r=(v/B)×(m/q)→r=(v/B)/(q/m)→B=v/(r×(q/m))→B=11.49254×10⁶/(0.5×10.80525×10⁶)=2.12721 Tesla

A superconducting magnet of 4.5 Tesla or higher and about 1 meter of bore is sufficient to confine radially the plasma (reactants and products).
The reactants (¹H+¹¹B) needs at least 123 KeV of kinetic energy for fusing, however 600 KeV is considered the best, nevertheless, in theory, only 123 KeV is consumed by the reaction. Losses caused by electromagnetic radiation (bremsstrahlung) are considered a fail of the coating of the magnet bore responsible to reflect the electromagnetic radiation back to plasma.
Calculation of a negative electric potential (first electric potential) for electrostatic acceleration of the positively charged particles to gain enough kinetic energy to fuse:

E=q×V→V=E/q→V=(E/m)/(q/m)→V=((10×600 KeV×1.60218×10⁻¹⁹)/207.58898×10⁻²⁷)/10.80525×10⁶=428.57165×10³ Volts

Temperature: 600×10³×(11604.505 K−273.15)=6.79881 billion ° C.

An electric potential (first electric potential) of −430 KV is enough to the charged particles gain the required energy kinetic of about 7 billions ° C.
Calculation of a positive potential (second electric potential) to confine longitudinally the reactants allowing the charged products (helium-4) escaping. A kinetic energy choice between reactants 600 KeV and products 8.68 MeV would be something about 1.4 MeV:

E=q×V→V=E/q→V=(E/m)/(q/m)

V=((10×1.4 MeV×1.60218×10⁻¹⁹)/207.58898×10⁻²⁷)/10.80525×10⁶=928.57191×10³ Volts

V=928.57191×10³−430 KV=498.57191×10³ Volts

A positive electric potential (second electric potential) of +500 KV is enough to confine the reactants allowing the products to escape.
As aforesaid, fusing positively charged particles represents a normal energy production and low bremsstrahlung radiation, otherwise fusing negatively charged particles represents a high energy production and high bremsstrahlung radiation, however, for highest energy production, the specific ionization must keep as low as possible, that is the plasma charged particles must be a quasi-neutral plasma resulting in a high density, which implies in a higher magnetic flux and a higher acceleration and confinement voltage. The consumption of the reactor at power of 200MWatts using a fuel with specific energy of 66.03921×1012 J/Kg:

200 MW=200×10⁶ J/s→200×10⁶ J/s/66.03921×10¹² J/Kg=3.02850×10⁻⁶ Kg/s

A fuel consumption of 3.03 milligrams per second is enough for producing 200MWatts.
Ion source current: 3.02850×10⁻⁶ Kg/s×10.80525×10⁶ C/Kg=32.72374 C/s
The ion injector belt must provide a current of at least 32.8 Amperes for producing 200MWatts.
Cyclotron frequency: f=qB/(2πm)=(q/m)×(B/2π)=10.80525×10⁶×4.5/(2×3.14159)=7.73869 MHz
Magnetic pressure: pm=B²/2μ°=4.5²/(2×4π×10⁷)=8.05721×10⁶ J/m³ 8.05721×10⁶/101325=79.51848 atmospheres
Acceleration of a spacecraft of 500000 Kg (500 tons) at power of 200MWatts:

200 MWatts in 1 s→200×10⁶ Joule→E=½mv²→200×10⁶=½×500000×v²→v=28.28427 m/s

a=Δv/Δt→a=28.28427 m/s²→g-force=28.28427/9.80665=2.88419 g

f=ma→f=500000×28.28427→f=14.14223×10⁶N

The formula E=½mv² refers to the action and reaction (Newton's third law) between the spacecraft and the exhausting products and not between the spacecraft and the origin point or launching site.
In the outer space, half of the energy goes to the exhausting products:

½E=½ mv²→E=mv²→200×10⁶=500000×v²→v=20 m/s→a=Δv/Δt→a=20 m/s²→g-force=2.0 g

A power of 200MWatts is enough for a spacecraft of 500000 Kg (500 tons) reach an acceleration of 28.2 m/s² (2.8 g-force) in the Earth's atmosphere and 20 m/s² (2 g-force) in the outer space.
A travel between Earth and Mars (closest=55758006 km and farthest=400000000 km) at an acceleration of 20 m/s² (2 g-force):

Midway: s=(10³×(55758006+400000000)/2)/2=113.93950×10⁹m

s=s₀+v₀t+½at²→113.93950×10⁹=0+0+½×20×t²→t=106.74244×10³ s→t×2≈3 days

v=v₀+at→v=0+20×106.74244×10³→v=2.13485×10⁶ m/s→v=7.68546×10⁶ Km/h

v²=v₀²+2aΔs→v²=0+2×20×113.93950×10⁹→v=2.13485×10⁶ m/s→v=7.68546×10⁶ Km/h

Fuel consumption: 3.02850×10⁻⁶×(2×106.74244×10³)=0.64653 Kg

Mass converted into energy: 4.12183×10³²×0.64653×1.782662×10⁻³⁶=0.000475 Kg (0.073%)

The travel between Earth and Mars, including acceleration and deceleration, will take 3 days and a decaborane consumption of 0.647 Kg, reaching a maximum velocity of 7.68×10⁶ Km/h at the midway.
A travel between Earth and Moon (perigee=348200 km and apogee=402100 km):

Midway: s=(10³×(348200+402100)/2)/2=187.575×10⁶m

s=s₀+v₀t+½at²→187.575×10⁶=0+0+½×20×t²→t=4.33099×10³ s→t×2≈3 hours

v²=v₀²+2aΔs→v²=0+2×20×187.575×10⁶→v=86.61986×10³ m/s→v=311.83149×10³ Km/h

Fuel consumption: 3.02850×10⁻⁶×(2×4.33099×10³)=0.026232 Kg

Mass converted into energy: 4.12183×10³²×0.026232×1.782662×1036=0.0000193 Kg (0.073%)

The travel between Earth and Moon, including acceleration and deceleration, will take 3 hours and a decaborane consumption of 0.027 Kg, reaching a maximum velocity of 311.83×10³ Km/h at the midway. Time to overwhelm the speed of light barrier (299792458 m/s) at an acceleration of 20 m/s² (2 g-force):

v=v₀+at→299792458=0+20×t→t=14.98963×10⁶ s→t≈5 months and 25 days

Fuel consumption: 3.02850×10⁻⁶×14.98963×10⁶=45.39072 Kg

Mass converted into energy: 4.12183×10³²×45.39072×1.782662×10⁻³⁶=0.033356 Kg (0.073%)

The time for overwhelming the speed of light barrier is about 5 months and 25 days at an acceleration of 20 m/s² with decaborane consumption about of 45.4 Kg.
A travel between Earth and Alpha Centauri star (4.365 light years≈1.338 parsec≈41.28666×10¹⁵ m):

Midway: s=41.28666×10¹⁵/2=20.64333×10¹⁵ m

s=s₀+v₀t+½ at²→20.64333×10¹⁵=0+0+½×20×t²→t=45.43493×10⁶ s→t×2≈2 years and 11 months

v²=v₀²+2aΔs→v²=0+2×20×20.64333×10¹⁵→v=908.69862×10⁶ m/s→v=3.27131×10⁹ Km/h≈3.031c

Fuel consumption: 3.02850×10⁻⁶×(2×4.33099×10³)=275.19937 Kg

Mass converted into energy: 4.12183×10³²×275.19937×1.782662×10⁻³⁶=0.202212 Kg

The travel between Earth and Alpha Centauri star, including acceleration and deceleration, will take 2 years and 11 months and a decaborane consumption of 275.2 Kg, reaching a maximum velocity of 3.27131×10⁹ Km/h, about three times the speed of light, at the midway.

### Global Warming Problem:

World energy consumption per year is about 500 EJ (500×10¹⁸ Joule 138.889 TWh)

Specific energy of the fossil fuels: 13 KWh/Kg=46.9×10⁶J/Kg

Fossil fuel consumption: 500×10¹⁸/46.9×10⁶=10.66098×1012 Kg

That is about 10.66 billion tons of carbon dioxide (CO₂) and other toxic gases going to atmosphere each year increasing the greenhouse effect.

### Global Warming Solution:

Specific energy of the decaborane: 18×10⁶ KWh/Kg=66×10¹²J/Kg

Decaborane consumption: 500×10¹⁸/66×10¹²=7.57575×10⁶ Kg

That will be only 7576 tons of clean, inert, safe and light helium gas ascending above the ozone layer per year. Some helium gas may escape to the outer space and be swept by the solar wind.

### Deforestation for Food Production Solution:

For save the biodiversity and to reduce the destruction of forested areas to be used as arable land and pasture for food production. This disclosure as energy source and an improvement in food technology is possible to synthesize carbohydrates, monounsaturated fats, proteins and vitamins, using electrochemical process, without toxic elements (e.g., mercury, lead), without radioactive elements (e.g., carbon-14, potassium-40), without animal corpse consumption (e.g., foot-and-mouth disease, mad-cow disease, avian influenza). The electrochemical food production will be worthwhile for outer space travels too.

This disclosure has no technical drawbacks, no environmental damage, and is more feasible than any other renewable energy like wind power, solar energy, hydroelectricity, and biofuels; all of them have low energy density requiring a lot of hectares.

### CONCLUSION, RAMIFICATIONS, AND SCOPE OF INVENTION

Accordingly, the reader will see that the nuclear fusion reactor of this invention evolve an improved fusion energy concept, that can be used to generate electricity at high efficiency; to thrust a spacecraft at very high performance levels, exceeding conventional means by specific impulse (propellant efficiency) factors of 2600-4680 at an inexpressive radiation hazards requiring insignificant shielding; most of fusion product is the helium that is safe and a non toxic waste; and as alternative source of energy can reduce the global warming problem; and also is relatively inexpensive and have abundant fuel supply, has scalability of size and power, easier engineering and maintainability.

While my above description contains a lot of specificities, these should not be construed as limitations on the scope of the invention, but rather as an exemplification of one preferred embodiment thereof. Many other variations are possible. For example, it can be comprised by two, three, four, five, six, seven, height magnets, and so on, varying form and size of the parts. It will be appreciated by those of ordinary skill in the art that various changes can be made in the parts and steps of the apparatus and method without departing from the spirit and scope of the invention.

Accordingly, the scope of the invention should be determined not by the embodiments illustrated, but by the appended claims and their legal equivalents.

1.-28. (canceled)

29. A method of confining and fusing charged particles, comprising the steps of:
(a) providing a means for generating at least two, preferably six, magnetic fields, wherein each of one ends, having same magnetic polarity, preferably south, of said magnetic fields are joined together forming a region of magnetic cusps,
(b) applying a first electric potential establishing a first electric field around the said region of magnetic cusps,
(c) applying a second electric potential of opposite polarity of said first electric potential around each of opposite ends, preferably north, of said magnetic fields, establishing a second electric field,
(d) injecting, preferably continuously, charged particles having a predetermined kinetic energy and with opposite electric polarity of said first electric potential, inwardly toward, and preferably along the length of, said magnetic cusps reaching the interior of said magnetic fields with a sufficient kinetic energy to fuse,
whereby said charged particles will be confined radially by said magnetic fields and trapped longitudinally by said first and second electric fields in the interior of said magnetic fields, until said charged particles fuse and their charged products may escape longitudinally overcoming said second electric field,
wherein for trapping positively charged particles then said first electric potential must have a negative voltage, and said second electric potential must have a positive voltage, otherwise for trapping negatively charged particles then said first electric potential must have a positive voltage, and said second electric potential must have a negative voltage,
wherein said voltages are relative to a common electric potential,
whereby fusing said positively charged particles represents a low bremsstrahlung radiation and fusing said negatively charged particles represents a high energy production, for a highest energy production the specific ionization of said charged particles must be substantially low in a quasi-neutral state.

30. The method of claim 29, wherein step (d) said injecting charged particles, further including the step of:
producing charged particles from a nuclear fusion fuel, wherein for producing
(a) said positively charged particles is by extracting electrons from said nuclear fusion fuel and sending said electrons to the said common electric potential, otherwise for producing
(b) said negatively charged particles is by extracting electrons from said common electric potential and adding said electrons to the said nuclear fusion fuel,
whereby said charged particles can exchange its potential energy to kinetic energy in an electrostatic way toward to the said first electric potential reaching sufficient kinetic energy to fuse with an inexpressive energy consumption.

31. The method according to claim 29, further including the step of:
converting energy of said charged products to electric energy and vice-versa, comprising the steps of:
(a) applying a third electric potential establishing a third electric field around the exhaust flow path of said charged products,
(b) neutralizing said charged products by injecting neutralizer particles toward to them,
whereby said charged products will easily attract said neutralizer particles,
(c) providing a means, preferably a switching-mode technology, for controlling a flow of electrons between said common electric potential and said third electric potential restoring its electric voltage, wherein
(d) for converting energy of said charged products to electric energy, then said third electric field is to force an exchange of the kinetic energy to a potential energy of said charged products, and
if said charged products are positively charged then said third electric potential must have a positive voltage, and said neutralizer particles are electrons extracted from said third potential increasing its voltage, and said means for controlling flow of electrons allows said flow of electrons from said common electric potential to the said third electric potential decreasing its electric voltage, otherwise
if said charged products are negatively charged then said third electric potential must have a negative voltage, and said neutralizer particles are positive ions which electrons were extracted and sent to the said third electric potential increasing its electric voltage, and said means for controlling flow of electrons allows said flow of electrons from said third electric potential to the said common electric potential decreasing the electric voltage of said third electric potential,
whereby said flow of electrons versus said exchange to potential energy represents energy flow received from said charged products before become neutralized and by having decreased its kinetic energy, otherwise
(e) for transferring said electric energy to the said charged products, then said third electric field is to increase the kinetic energy of said charged products,
if said charged products are positively charged then said third electric potential has a negative voltage and said neutralizer particles are electrons extracted from said third potential decreasing its voltage, said means to control flow of electrons pull electrons from said common electric potential to the said third electric potential increasing its electric voltage, otherwise
if said charged products are negatively charged then said third electric potential has a positive voltage and said neutralizer particles are positive ions which electrons were extracted and sent to the said third electric potential decreasing its electric voltage, and said means to control flow of electrons pull electrons from said third electric potential to the said common electric potential increasing the electric voltage of said third electric potential,
whereby said flow of electrons versus said increasing of kinetic energy represents energy flow transferred to the said charged products after become neutralized by having increased its kinetic energy,
whereby using aneutronic fuels, preferably boron hydrides and helium-3, the converting energy method above will exceed 95% of efficiency.

32. The method according to claim 29 wherein in step (a) providing a means for generating magnetic fields,
wherein said means for generating magnetic fields further comprises a set of variable magnetic flux means, preferably four, adjustable independently from each other,
whereby said magnetic fields act as a magnetic lens confining and focusing said charged particles and each of said variable magnetic flux means can be adjusted to shape said magnetic fields to achieve a best focal length increasing the fusion rate.

33. The method according to claim 29 wherein in step (a) providing a means for generating magnetic fields, further including the step of:
(i) providing a means to induce oscillations on magnetic flux, preferably by pulses on electric current, of said means for generating magnetic fields, wherein said oscillations comprises a modulation of a plurality of frequencies, and
(ii) measuring energy production and adjusting said oscillations to reach maximum of said energy production, meaning that a maximum synchronization of phase and frequency with said charged particles has been reached,
whereby most of the energy of said magnetic flux oscillations will be transferred radially to the said charged particles increasing the fusion rate.

34. The method according to claim 29, further including the step of:
(a) providing a means for inducing oscillations on electric voltage of said first and second electric potential, preferably both, wherein said oscillations comprises a modulation of a plurality of frequencies, and
(b) measuring energy production and adjusting said oscillations to reach maximum said energy production, meaning that a maximum synchronization of phase and frequency with said charged particles has been reached,
whereby most of the energy of said electric oscillations will be transferred longitudinally to the said charged particles increasing the fusion rate.

35. The method according to claim 29 wherein in step (a) providing a means for generating magnetic fields, further including the step of:
(i) providing a coil winding for said means for generating magnetic fields comprised by a plurality of flat pancake coils disposed longitudinally no overlapping each other,
(ii) providing a bore electrically insulated at least axially,
whereby oscillations on electric current of said means for generating magnetic fields will induce an alternating electric field in the said bore transferring energy axially to the said charged particles increasing the fusion rate,
whereby using means for increasing the fusion rate will decrease electric charge in the reaction chamber allowing injection of more said charged particles increasing the energy production.

36. The method according to claim 29 wherein in step (a) providing a means for generating magnetic fields, further including the step of:
providing a coating for the bore of said means for generating magnetic fields, comprised by a hard and dense metal alloy of tungsten or depleted uranium, preferably covered by a layer of a dielectric material like silicon dioxide or titanium dioxide, for reflecting electromagnetic radiation from said charged particles back to them, and preferably said coating be done in an annular way or using powder compound of said metal alloy for providing an axial electrical insulation,
whereby said bore coating will recycle the energy of said electromagnetic radiation increasing the fusion rate and keeping low the temperature of said bore.

37. The method according to claim 29, further including the step of: providing a power supply system, comprising the steps of:
(a) providing an electrical transformer with a plurality of windings no overlapping each other,
(b) providing a power supply means comprised by a switching-mode full bridge technology,
(c) providing a means for the said power supply reversing its electrical polarity,
(d) providing a built-in means to control said power supply means,
(e) providing a means to the said built-in control receive commands and send its status via an optical fiber,
(f) providing a plurality of said power supply means and connecting each one to each winding of said electrical transformer,
whereby one of the said power supply means can be commanded to send its electric energy to the said electrical transformer and another power supply means can be commanded to receive said electric energy from said electrical transformer and vice-versa,
whereby the said power supply system can be commanded via an optical fiber to provide a multidirectional energy flow.

38. The method according to claim 29, further including the step of:
providing a control system using an optical fiber bus for commanding and monitoring the status of a plurality of electrical components of the nuclear fusion reactor via a semi-duplex protocol,
whereby said optical fiber is immune to electrical interference and has a high electrical insulation worthwhile to command and monitor high voltage power supplies and ion sources.

39. An apparatus for confining and fusing charged particles comprising:
a means for generating at least two, preferably six, magnetic fields, wherein each of one ends, having same magnetic polarity, preferably south, of said magnetic fields are joined at a common location forming an intersection region having a plurality of openings,
a means for establishing a first electric field at the said intersection region,
a means for establishing a second electric field of opposite polarity of said first electric field around each of distal ends, preferably north, of said means for generating magnetic fields,
wherein said openings are for injecting, preferably continuously, charged particles having a predetermined kinetic energy and with opposite electric polarity of said first electric field, inwardly toward to the chamber interior,
whereby said charged particles will be confined radially by said magnetic fields and trapped longitudinally by said first and second electric fields into said chamber interior, and the said intersection region are protected by phenomenon of magnetic reconnection, until said charged particles fuse and their charged products may escape longitudinally overcoming said second electric field,
wherein for trapping positively charged particles then said means for establishing said first electric field must provide a negative electric voltage and said means for establishing said second electric field must provide a positive electric voltage,
otherwise for trapping negatively charged particles then said means for establishing said first electric field must provide a positive electric voltage and said means for establishing said second electric field must provide a negative electric voltage,
wherein said voltages are relative to a common electric potential,
whereby fusing said positively charged particles represents a low bremsstrahlung radiation and otherwise fusing said negatively charged particles represents a high energy production, for a highest energy production the specific ionization of said charged particles must be substantially low in a quasi-neutral state.

40. The apparatus of claim 39, further comprising:
a means for injecting said charged particles into said plurality of openings, comprising:
a means for producing said charged particles from a nuclear fusion fuel by exchanging electrons with said common electric potential, preferably producing either positively or negatively charged particles,
an electrical insulation means for connecting said means for producing said charged particles to the said openings which is at the said first electric field,
a means for measuring flow of said nuclear fusion fuel and flow of said electrons in order to determine the specific ionization,
whereby said charged particles can exchange its potential energy to kinetic energy electrostatically toward to the said openings, reaching great kinetic energy at an inexpressive energy consumption.

41. The apparatus according to claim 39, further comprising:
a means for converting energy of said charged products to electric energy and vice-versa, comprising:
a power supply means for establishing a third electric field around the exhaust flow path of said charged products,
a means for neutralizing said charged products by injecting neutralizer particles toward to them, whereby said charged products will easily attract said neutralizer particles,
wherein said power supply means has a built-in means, preferably a switching-mode technology, for controlling flow of electrons between said common electric potential and said power supply means restoring its electric voltage,
wherein for converting energy of said charged products into electric energy, then said third electric field is to force an exchange of the kinetic energy to a potential energy of said charged products,
if said charged products are positively charged then said power supply means must provide a positive voltage, and said neutralizer particles are electrons extracted from said power supply means increasing its electric voltage, and said means for controlling flow of electrons allows said flow of electrons from said common electric potential to the said power supply means decreasing its electric voltage, otherwise
if said charged products are negatively charged then said power supply means must provide a negative voltage, and said neutralizer particles are positive ions which electrons were extracted and sent to the said power supply means increasing its electric voltage, and said means for controlling flow of electrons allows said flow of electrons from said power supply means to the said common electric potential decreasing the electric voltage of said power supply means,
whereby said flow of electrons versus said exchange to potential energy represents energy flow received from said charged products before become neutralized and by having decreased its kinetic energy,
otherwise for transferring said electric energy to the said charged products, then said third electric field is to increase the kinetic energy of said charged products,
if said charged products are positively charged then said power supply means must provide a negative voltage and said neutralizer particles are electrons extracted from said power supply means decreasing its electric voltage, said means to control flow of electrons pull electrons from said common electric potential to the said power supply means increasing its electric voltage, otherwise
if said charged products are negatively charged then said power supply means must provide a positive voltage and said neutralizer particles are positive ions which electrons were extracted and sent to the said power supply means decreasing its electric voltage, and said means to control flow of electrons pull electrons from said power supply means to the said common electric potential increasing the electric voltage of said power supply means,
whereby said flow of electrons versus said increasing of kinetic energy represents energy flow transferred to the said charged products after become neutralized by having increased its kinetic energy,
whereby using aneutronic fuels, preferably boron hydrides and helium-3, the converting energy apparatus above will exceed 95% of efficiency.

42. The apparatus according to claim 39, wherein said means for generating magnetic fields further comprises a magnet divided in winding groups, preferably four groups, where adjustment of magnetic flux of each group is independent of the other one,
whereby said magnetic fields act as a magnetic lens confining and focusing said charged particles and each of said variable magnetic flux means can be adjusted to shape said magnetic fields to achieve a best focal length increasing the fusion rate.

43. The apparatus according to claim 39, wherein said means for generating magnetic fields, further including:
a means for inducing oscillations on magnetic flux, preferably by pulses on electric current, of said means for generating magnetic fields, wherein said oscillations comprises a modulation and multiplexing of a plurality of frequencies,
whereby most of the energy of said magnetic flux oscillations will be transferred radially to the said charged particles increasing the fusion rate.

44. The apparatus according to claim 39, further including:
a means for inducing oscillations on electric voltage of said means for establishing the first and the second electric field, preferably both, wherein said oscillations comprises a modulation and multiplexing of a plurality of frequencies,
whereby most of the energy of said electric oscillations will be transferred longitudinally to the said charged particles increasing the fusion rate.

45. The apparatus according to claim 39, wherein said means for generating magnetic fields, further including:
a bore electrically insulated at least axially and a coil winding comprised by a plurality of flat pancake coils disposed longitudinally no overlapping each other,
whereby oscillations on electric current of said means for generating magnetic fields will induce an alternating electric field in the said bore transferring energy axially to the said charged particles increasing the fusion rate,
whereby using means to increase the fusion rate will decrease electric charge in the reaction chamber allowing injection of more said charged particles increasing the energy production.

46. The apparatus according to claim 39, wherein said means for generating magnetic fields, further including:
a bore coated by a hard and dense metal alloy of tungsten or depleted uranium, preferably covered by a layer of a dielectric material like silicon dioxide or titanium dioxide, for reflecting electromagnetic radiation from said charged particles back to them, and preferably done in an annular way or using powder compound of said metal alloy for providing an axial electrical insulation,
whereby said bore coated will recycle the energy of said electromagnetic radiation increasing the fusion rate and keeping low the temperature of said bore.

47. The apparatus according to claim 39, further including:
a power supply system, comprising:
an electrical transformer with a plurality of windings no overlapping each other,
a power supply means comprised by a switching-mode full bridge technology,
a means for the said power supply means for reversing its electrical polarity,
a built-in means to control said power supply means,
a means to the said built-in means receive commands and send its status via an optical fiber,
wherein a plurality of said power supply means is connected to each winding of said electrical transformer,
whereby one of the said power supply means can be commanded to send electric energy to the said electrical transformer and another power supply means can be commanded to receive said electric energy from said electrical transformer and vice-versa,
whereby the said power supply system can be commanded via an optical fiber to provide a multidirectional energy flow.

48. The apparatus according to claim 39, further including:
a control system using an optical fiber bus for commanding and monitoring the status of a plurality of electrical components of the nuclear fusion reactor via a semi-duplex protocol,
whereby said optical fiber is immune to electrical interference and has a high electrical insulation worthwhile to command and monitor high voltage power supplies and ion sources.
